(19) United States
(12) Patent Application Publication
(10) Pub. No.: US 2010/0095386 A1
(43) Pub. Date: Apr. 15, 2010

(54) Realest invention

(76) Inventor: Theodoros H. Asimakopoulos, Silver Spring, MD (US)

Correspondence Address: Theodoros Asimakopoulos, 3703 Jeffry St, Silver Spring, MD, 20906, US

(21) Appl. No.: 12/456,809

(22) Filed: Jun. 23, 2009

Related U.S. Application Data
(60) Provisional application No. 61/075,321, filed on Jun. 24, 2008.

(51) Int. Cl. G06F 21/00

(52) U.S. Cl. 726/31

(57) ABSTRACT

Music files that are downloaded from the internet are encrypted so that they are compatible with cd burning and allow music or movie files to be copied to disc a predetermined amount of time (either once or twice). Now disc burning programs only allow files (movies, music) from internet to be burned once or twice. These are the new ones that come out (disc burning programs). The old ones still operate the way they do unless running into newly encrypted files.

Music files that are downloaded from the internet are encrypted so that they are compatible with cd burning and allow music or movie files to be copied to disc a predetermined amount of time (either once or twice). Now disc burning programs only allow files (movies, music) from internet to be burned once or twice. These are the new ones that come out (disc burning programs). The old ones still operate the way they do unless running into newly encrypted files.

### BACKGROUND OF THE INVENTION

Previous to this anti theft burning there was a lot of theft, now that someone can determine through specification and abstract that there now less theft.

### BRIEF SUMMARY OF THE INVENTION

Music files that are downloaded from the internet are encrypted so that they are compatible with cd burning and allow music or movie files to be copied to disc a predetermined amount of time (either once or twice). Now disc burning programs only allow files (movies, music) from internet to be burned once or twice. These are the new ones that come out (disc burning programs). The old ones still operate the way they do unless running into newly encrypted files.

### DETAILED DESCRIPTION OF THE INVENTION

Music files that are downloaded from the internet are encrypted so that they are compatible with cd burning and allow music or movie files to be copied to disc a predetermined amount of time (either once or twice). Now disc burning programs only allow files (movies, music) from internet to be burned once or twice. These are the new ones that come out (disc burning programs). The old ones still operate the way they do unless running into newly encrypted files.

1. Music files that are downloaded from the internet are encrypted so that they are compatible with cd burning and allow music or movie files to be copied to disc a predetermined amount of time (either once or twice).

2. Disc burning programs only allow files (movies, music) from internet to be burned once or twice. These are the new ones that come out (disc burning programs). The old ones still operate the way they do unless running into newly encrypted files.
